(19) United States
(12) Patent Application Publication
(10) Pub. No.: US 2004/0083151 A1
(43) Pub. Date: Apr. 29, 2004

(54) Method for generating a portfolio of stocks

(76) Inventors: Chuck R. Craig, Naperville, IL (US); Michael R. Boyle, Batavia, IL (US)

Correspondence Address: MCANDREWS HELD & MALLOY, LTD, 500 WEST MADISON STREET, SUITE 3400, CHICAGO, IL, 60661

(21) Appl. No.: 10/282,657

(22) Filed: Oct. 29, 2002

(51) Int. Cl. G06F 17/60

(52) U.S. Cl. 705/36

(57) ABSTRACT

A method is provided for selecting a portfolio of securities for investment purposes. Specifically, the method comprises assigning a numerical rank to each economic sector of the group of available securities according to market capitalization. A predetermined number of economic sectors are selected based on the numerical ranking. The method goes on to rank return on assets, buyback yield, and bullish interest indicator for each security in each selected economic sector and then combines the rankings and assigns a final numerical rank to each security within each selected economic sector. A predetermined number of securities from each selected economic sector are then selected based on the final numerical rank to form the investment portfolio.

### CROSS-REFERENCE TO RELATED APPLICATIONS/INCORPORATION BY REFERENCE

U.S. application Ser. No. 09/469,917 filed on Dec. 22, 1999 is incorporated herein by reference in its entirety.

### BACKGROUND OF THE INVENTION

A unit investment trust (UIT) is a professionally selected, diversified portfolio of stocks, bonds, or other securities that remains as a fixed portfolio throughout the life of the trust. Investors in a UIT purchase units, which represent an undivided ownership in the entire portfolio. Unlike mutual funds, in which the portfolio is actively managed and traded and continuously changes, UITs generally remain fixed for a predetermined period of time. Portfolios are designed to fill a variety of investment needs and risk tolerance levels. They fall into primarily two categories, equity and fixed income.

Equity portfolios are typically classified as either strategies or sectors. Strategy portfolios follow predetermined investment criteria for selecting the stocks for the portfolio. All strategies have three inherent qualities:

1. Simplicity: The strategies seek to out-perform specified indices by selecting portfolios using sound, fundamental and technical, screens that reflect the historical behavior of the securities.

2. Resilience: The strategies must show back-tested results and have staying power even through bear markets.

3. Discipline: The strategies dictate which stocks are chosen for the portfolio; no emotional judgments are made and the strategies always remain the same.

Developing a strategy that robustly meets these criteria can be very difficult, if not elusive. Investment strategies have been illustrated in U.S. Pat. No. 5,978,778 issued to O'Shaughnessy on Nov. 2, 1999 and U.S. Pat. No. 5,132,899 issued to Fox on Jul. 21, 1992.

Further limitations and disadvantages of conventional and traditional approaches will become apparent to one of skill in the art, through comparison of such strategies with the present invention as set forth in the remainder of the present application with reference to the drawings.

### SUMMARY OF THE INVENTION

Certain embodiments of the present invention generally relate to selecting a securities portfolio for investment. More particularly, certain embodiments of the present invention relate to an investment strategy for selecting a securities portfolio based on market capitalization, return on assets, buyback yield, and bullish interest indicator. The investment objective of embodiments of the present invention is to provide an above-average total return from the portfolio. Embodiments of the present invention seek to meet the objective through capital appreciation. Embodiments of the present invention provide a novel security selection investment strategy and automate the investment strategy.

A method is provided in a computer implementation for selecting securities from a group of available securities for an investment portfolio. The method comprises assigning a numerical rank to each economic sector of the group of available securities according to market capitalization. A predetermined number of economic sectors are selected based on the numerical ranking. The method goes on to rank return on assets, buyback yield, and bullish interest indicator for each security in each selected economic sector and then combines the rankings and assigns a final numerical rank to each security within each selected economic sector. A predetermined number of securities from each selected economic sector are then selected based on the final numerical rank to form the investment portfolio.

These and other advantages and novel features of the present invention, as well as details of an illustrated embodiment thereof, will be more fully understood from the following description and drawings.

### BRIEF DESCRIPTION OF THE DRAWINGS

FIG. 1 is a schematic flow chart depicting the steps in an exemplary method of selection of securities in accordance with an embodiment of the present invention.

FIG. 2 is an exemplary illustration of selecting and weighting economic sectors and securities within a sector according to an embodiment of the present invention.

### DETAILED DESCRIPTION OF THE PREFERRED EMBODIMENTS

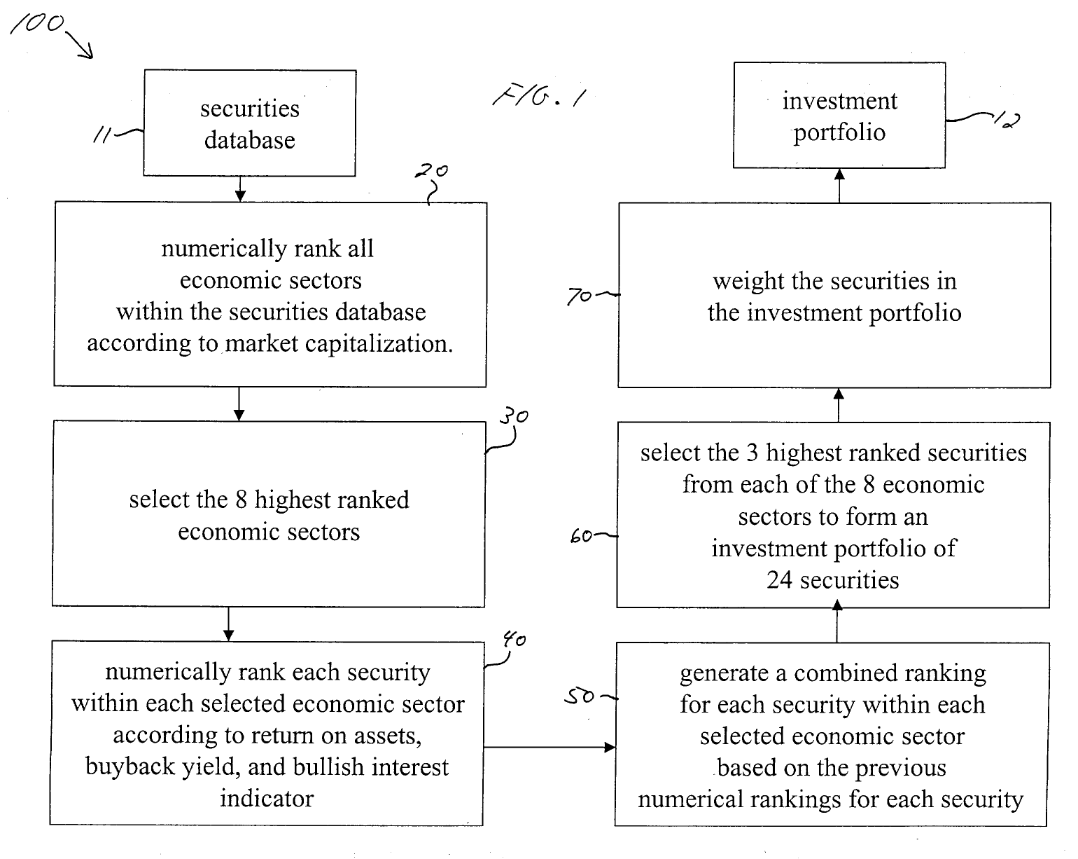

Referring to the FIG. 1, in the method 100, a securities database 11 is formed by input of data using a conventional PC computer (not shown). The data input includes the names of, or a representation of, the five hundred (500) stocks that make up the S&P 500 Index, in accordance with an embodiment of the present invention. The S&P 500 Index is a market-weighted index that consists of 500 stocks chosen for market size, liquidity, and economic sector representation. The names of the 500 stocks, or their symbols, or other representative indicia are stored in database 11.

In addition to the identity of the 500 stocks, other data related to each stock is also stored in database 11 in association with its respective stock name. Such information may include economic sector, market capitalization, trailing four quarters' return on assets, buyback yield, and bullish interest indicator.

Return on assets over the last four quarters is measured by quarterly income before extraordinary items, less preferred dividends, divided by average assets over the past four quarters. Buyback yield measures the percentage decrease in shares outstanding for the last year. The measure compares shares outstanding as reported in the most recent quarterly report to shares outstanding as reported four quarters earlier. All stocks with rising or flat shares outstanding are given a buyback yield of 0% and, therefore, receive the same ranking. The bullish interest indicator compares the amount of stock traded in months in which the price increased to the amount of stock traded in months in which the stock price decreased. Stocks with a higher percentage of the annual trade volume occurring in rising months receive a higher ranking (expressed as a percentage).

In step 20 of method 100, all of the economic sectors (e.g., Global Industry Classification System Sectors) of the stocks are numerically ranked according to market capitalization of those sectors. The market capitalization of a stock is simply the market value of all outstanding shares and is computed by multiplying the market price by the number of outstanding shares. The market capitalization of an economic sector is simply the sum of the market capitalizations of all the stocks in that sector.

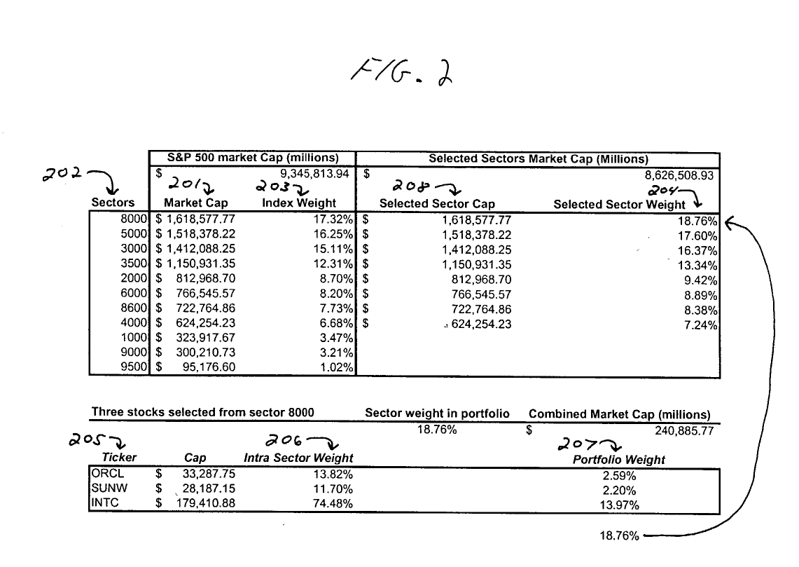

Referring to FIG. 2, the market capitalizations (Market Cap) 201 of a number of economic sectors (Sectors) 202 may be seen. For example, the market capitalization of sector 6000 is $766,545.57. Each economic sector has an index weight 203 which is simply a percentage of market capitalization across all of the sectors. For example, sector 6000 has an index weight of 8.20%. The index weights sum to 100%.

In accordance with an embodiment of the present invention, in step 30, the economic sectors 208 with the eight highest ranked market capitalizations are selected. In an embodiment of the present invention, a sorting algorithm may be used to aid in the selection. Notice, in FIG. 2, that the index weight (selected sector weight) 204 of each selected sector has changed. For example, the index weight for sector 8000 was 17.32% and is now, after selection, 18.76%. The weight has changed since the weightings of the selected economic sectors must sum to 100%.

Each economic sector comprises a number of individual stocks, usually related to a particular industry. Some economic sectors may contain more stocks than other economic sectors. In accordance with an embodiment of the present invention, in step 40, the stocks in each economic sector are numerically ranked, by factor, according to the three factors previously discussed which include the trailing four quarters' return on assets, buyback yield, and bullish interest indicator (i.e., one numeric ranking per factor). If a factor cannot be computed, it is given the lowest possible ranking.

For example, referring to FIG. 2, the three stocks from sector 8000 may end up with the following rankings for each factor as shown in the table below.

| | Factor 1 | | Factor 3 | |
|---|---|---|---|---|
| | (return on | Factor 2 | (bullish interest | Combined |
| Stock | assets) | (buyback yeild) | indicator) | Ranking |
| ORCL | 3 | 2 | 1 | 6 |
| SUNW | 2 | 3 | 2 | 7 |
| INTC | 1 | 1 | 3 | 5 |

In step 50, the numerical rankings for each stock (i.e., three rankings for each stock) are summed together to generate a combined numerical ranking, in accordance with an embodiment of the present invention. As a result, each stock in each economic sector will have a combined numerical ranking. For the table above, SUNW ends up with a highest combined ranking of 7, ORCL ends up with a second highest combined ranking of 6, and INTC with a third highest combined ranking of 5.

In accordance with an embodiment of the present invention, in step 60, the three highest ranked stocks, using the combined ranking, from each economic sector are selected to form an investment portfolio 12 of twenty-four (24) stocks. In an embodiment of the present invention, a sorting algorithm may be used to aid in the selection. If a tie in ranking occurs, market capitalization may be used to break the tie. For example, the stock with the greatest market capitalization may be selected.

In step 70, the stocks in the investment portfolio are weighted such that each stock in the portfolio will comprise a particular number of shares of that stock (i.e., number of shares to be purchased for each stock in the investment portfolio). The three stocks from each economic sector are weighted according to the relative market capitalization of each stock within the economic sector, in accordance with an embodiment of the present invention.

FIG. 2 illustrates the weighting of three stocks 205 (ORCL, SUNW, INTC) from an economic sector (intra sector weight) 206. For example, the weighting given to the three stocks is 13.82%, 11.70%, and 74.48% respectively. The 13.82% number is calculated as the market capitalization for the ORCL stock divided by the total market capitalization of the three stocks 205, multiplied by 100. The percentage weightings for the three stocks sum to a total of 100%.

Across the investment portfolio 12, the three stocks from each economic sector are weighted according to the relative market capitalizations of the 8 economic sectors, in accordance with an embodiment of the present invention. For example, referring again to FIG. 2, the total weight of the sector 8000 is 18.76% (selected sector weight) 204. Thus, the total weight given to the three stocks 205 (ORCL, SUNW, INTC) within the sector 8000 is 18.76% (portfolio weight) 207 which is the percent market capitalization for that economic sector 8000.

ORCL will receive a 13.82% weight 206 of the 18.76% total weight 207 for sector 8000 (i.e. ORCL will receive a 2.59% portfolio weight 207 within the investment portfolio 12).

A unit investment trust (UIT) is a professionally selected, diversified portfolio of stocks, bonds, or other securities that remains as a fixed portfolio throughout the life of the trust. It may be seen that the investment portfolio 12 may constitute a UIT. The trust will terminate on a mandatory termination date, which will typically be approximately 15 months from the initial date of deposit. Twelve-month termination dates are also contemplated. However, the duration of the investment vehicle is not limited to any particular length of time.

Some possible features and benefits of such a unit investment trust or other pooled vehicle or investment account may be summarized as follows (although these are not essential features of embodiments of the present invention):

Known Portfolio

The present method produces a specific portfolio giving investors the comfort of knowing what they own.

Diversification

Portfolios produced by the present method can be diversified across many different securities, offering a portfolio for almost every asset allocation need.

Low Expenses

Portfolios selected pursuant to the present method offer significantly lower expenses than other packaged products.

Daily Liquidity

Units may be redeemed on any business day at the redemption price, which may be more or less than the original purchase price. There is no cost to liquidate.

Professional Portfolio Selection and Supervision

Once the portfolio is chosen, the holdings of the portfolio are supervised, eliminating the need of individual investors to oversee each security.

Fully Invested in the Market

Portfolios selected pursuant to the present method have limited cash positions so more of the investor's money is working in the market.

Ease of Ownership

With one low minimum purchase, investors can own a diversified portfolio of securities without making a substantial commitment of time or capital.

Embodiments of the present invention are not limited to the selection of securities for funding a unit investment trust. Securities may be selected for funding any type of pooled investment vehicle or investment account. The present invention could also be used in connection with variable annuities, open-ended mutual funds, an investment account, etc.

Also, embodiments of the present invention are not limited to the S&P 500 Index. Other stock indexes or groups of stocks may also be used as the starting point for the securities database 11.

In an embodiment of the present invention, the method 100 is implemented on a personal computer.

In summary, aspects of the present invention provide for selecting a securities portfolio based on market capitalization, return on assets, buyback yield, and bullish interest indicator.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A computer implementation method for selecting securities from a group of available securities for an investment portfolio, said computer performing the steps comprising:
assigning a numerical rank to each economic sector of said group of available securities according to market capitalization;
selecting a predetermined number of economic sectors based on said assigning a numerical rank according to market capitalization;
assigning a composite numerical rank to each security in each selected economic sector according to at least one of return on assets, buyback yield, bullish interest indicator, or any combination thereof; and
selecting a predetermined number of securities from said each selected economic sector based on said composite numerical rank of said each security in said each selected economic sector to form said investment portfolio.

2. The method of claim 1 wherein said group of securities comprises the 500 stocks that make up the Standard and Poor's 500 Composite Stock Price Index.

3. The method of claim 1 wherein said selected economic sectors comprise eight economic sectors with the highest market capitalization.

4. The method of claim 1 wherein said return on assets is measured as quarterly income before extraordinary items less preferred dividends divided by average assets over a past four quarters.

5. The method of claim 1 wherein said buyback yield is measured as a percentage decrease in shares outstanding for a last year by comparing shares outstanding, as reported in a most recent quarterly report, to shares outstanding as reported four quarters earlier.

6. The method of claim 1 wherein said bullish interest indicator is measured by comparing an amount of stock traded in months in which a corresponding stock price declined, and wherein stocks with a higher percentage of annual volume occurring in rising months receive a higher ranking.

7. The method of claim 1 wherein said predetermined number of securities comprises three securities from said each economic sector having a highest said composite numerical rank.

8. The method of claim 1 further comprising assigning, to said each security in said each selected economic sector, a first numerical rank based on said return on assets, a second numerical rank based on said buyback yield, and a third numerical rank based on said bullish interest indicator.

9. The method of claim 8 wherein said assigning a composite numerical rank to said each security comprises summing said first numerical rank, said second numerical rank, and said third numerical rank of said each security to generate said composite numerical rank for said each security.

10. The method of claim 1 further comprising weighting said predetermined number of securities from said each selected economic sector according to a relative market capitalization of said each security of said predetermined number of securities within said each selected economic sector.

11. The method of claim 1 further comprising weighting said investment portfolio according to a relative market capitalization of said each sector of said predetermined number of economic sectors selected.

12. The method of claim 1 further comprising purchasing said selected, predetermined number of securities from said each selected economic sector, said purchased securities thereby forming said investment portfolio.

13. The method of claim 1 further comprising creating any pooled investment vehicle comprising said predetermined number of securities from said each selected economic sector.

14. The method of claim 1 further comprising creating a variable annuity comprising said predetermined number of securities from said each selected economic sector.

15. The method of claim 1 further comprises creating an investment account comprising said predetermined number of securities from said each selected economic sector.

16. The method of claim 1 further comprising creating an open-ended mutual fund comprising said predetermined number of securities from said each selected economic sector.

17. The method of claim 1 wherein said method is implemented on a computer as a software application program.

18. The method of claim 1 further comprising generating a securities database that may be stored, executed, and used by a computer.

19. The method of claim 1 wherein said investment portfolio is generated and stored as a computer file within said computer implementation.

20. The method of claim 1 wherein a sorting algorithm is used in said selecting a predetermined number of economic sectors and said selecting a predetermined number of securities.
